(19) United States
(12) Patent Application Publication
(10) Pub. No.: US 2019/0279097 A1
(43) Pub. Date: Sep. 12, 2019

(54) SYSTEMS AND METHODS FOR DECISION TREE ENSEMBLES FOR SELECTING ACTIONS

(71) Applicant: General Electric Company, Schenectady, NY (US)

(72) Inventors: Paul David Baines, El Cerrito, CA (US); Joseph William Richards, El Cerrito, CA (US); Damian Ryan Eads, San Francisco, CA (US)

(21) Appl. No.: 15/914,325

(22) Filed: Mar. 7, 2018

(51) Int. Cl. G06N 5/02; G06F 17/30

(52) U.S. Cl. CPC G06N 5/02; G06F 17/30961

(57) ABSTRACT

Various embodiments provide systems and methods for an ensemble of decision trees that assists in selection of a predicted action to achieve a desired outcome based on an input comprising a set of feature values, such as an input feature vector for a particular instance. The predicted action may represent an optimal or best action, from the plurality of possible actions, for achieving the desired outcome.

### TECHNICAL FIELD

The present application relates to ensemble models and, more particularly, decision tree ensembles relating to selection of an action for a set of feature values.

### BACKGROUND

Decision tree ensembles, such as those based on RANDOM FOREST, are typically used to predict quantities. A decision tree ensemble usually comprises a plurality of decision trees, where each decision tree may comprise a tree-like graph of decisions and their possible consequences, and may further comprise probabilities for those consequences. A decision tree ensemble can use the output of multiple decision trees based on the same input data to obtain a combined predictive output. Generally, a RANDOM FOREST-based algorithm is used to generate a plurality of decision trees for an ensemble, and the ensemble is then trained on training data. Subsequently, the trained ensemble processes an input feature vector to generate an output by processing the input feature vector by each decision tree in the trained ensemble, and the resulting votes from each of the decision trees determines the output of the trained ensemble. The output would provide the predicted quantity for the input feature vector.

However, conventional decision tree ensembles have not been used or adapted to select an action, such as an optimal or best action, for achieving a desired outcome in a given situation. In particular, traditional methods or functions for building decision trees are incapable of building decision trees capable of selecting an action that optimizes an outcome (e.g., assists in achieving a favorable or desired outcome). For example, a conventional decision tree ensemble are not designed to be trained and used to select an action (e.g., maintenance, repair, operational change, etc.) to take with respect to an industrial machine (e.g., jet engine, generator, wind turbine, etc.) that would prevent the industrial machine from failing within a certain time period (e.g., the next month), which would represent a favourable/desired outcome with respect to the industrial machine. Rather, a conventional decision tree ensemble is better suited, for example, in predicting whether the industrial machine is likely to fail in the next month (e.g., based on current diagnostic information provided by the industrial machine).

### BRIEF DESCRIPTION OF THE DRAWINGS

Some embodiments are illustrated by way of example and not limitation in the figures of the accompanying drawings.

FIG. 1 is a block diagram illustrating an example networked system including a decision tree ensemble model component for predicting actions, in accordance with some embodiments of the present disclosure.

FIG. 2 is a block diagram illustrating an example system including a decision tree ensemble model component for predicting actions, in accordance with some embodiments of the present disclosure.

FIG. 3 is a flow chart illustrating an example method for generating a decision tree ensemble for predicting an action, in accordance with some embodiments of the present disclosure.

FIG. 4 is a flow chart illustrating an example method for generating a decision tree of a decision tree ensemble for predicting an action, in accordance with some embodiments of the present disclosure.

FIG. 5 is a flow chart illustrating an example method for using a decision tree ensemble for predicting an action, in accordance with some embodiments of the present disclosure.

FIG. 6 is a diagram illustrating an example decision tree ensemble for predicting an action, in accordance with sonic embodiments of the present disclosure.

FIG. 7 is a block diagram illustrating an example software architecture, which may be used in conjunction with various hardware architectures herein described, according to various embodiments of the present disclosure.

FIG. 8 is a block diagram illustrating components of an example machine able to read instructions from a machine storage medium and perform any one or more of the methodologies discussed herein, according to various embodiments of the present disclosure.

### DETAILED DESCRIPTION

Various embodiments provide systems and methods for an ensemble of decision trees (also known as a decision forests) that assists in selection of a predicted action to achieve a favorable or desired outcome based on an input comprising a set of feature values, such as an input feature vector for a particular instance. For example, an ensemble of an embodiment may be generated such that based on a set of feature values relating to an industrial machine (such as values regarding a device's make, a device's model, or device diagnostic information), the ensemble could predict an optimal or best action for repairing the industrial machine when the industrial machine experiences a fault. In such an example, the ensemble may be part of an industrial analysis data system that analyzes data from industrial devices, such as generators, wind turbines, medical devices, jet engines, and locomotives, and assists in operation or operation optimization with respect to the industrial devices. Such foregoing embodiments take advantage of methodologies described herein for constructing decision tree ensembles useful for predicting an action to achieve a favorable or desired outcome based on a set of feature values.

An ensemble of decision trees that assists in selection of an action, in accordance with some embodiments, may be referred to herein as an action forest. As used herein, each different action may be represented by a different action value, and an action value can represent, for example, a course of action that can be taken or a selection that can be made by a human or a machine, which can result in an outcome. The outcome that result may or may not be favorable or desirable. The ensemble of decision trees of some embodiments assists in determining, in view of a set of conditions (e.g., represented by a set of feature values, which may be stored as a feature vector), a predicted action for achieving a desired outcome. The predicted action may represent an optimal or best action, from the plurality of possible actions, for achieving the desired outcome. As described herein, an action may be represented by an action value that is selected from a plurality of possible action values, and an outcome may be represented by an outcome value selected from a binary of possible outcome values, such as a binary outcome (e.g., two-class classification). Additionally, a set of conditions may be represented by a set of (feature) values for a set of features (e.g., variables) accepted and processed by an ensemble of decision trees to provide the predicted action.

According to some embodiments, an ensemble of decision trees is constructed based on the following. For a set of k possible action values Å={a₁, . . . , aₖ} and an input feature vector Xᵢ for an instance i, and an outcome Yᵢ for an instance i that has a binary outcome value of 1 or 0 (e.g., where 1 denotes a positive class, and 0 denotes a negative class), the ensemble can select, for an action Aᵢ for the instance i, from the set of k possible actions Å={a₁, . . . , aₖ} that maximizes the probability of outcome Yᵢ=1 in view of the input feature vector Xᵢ. For example, where the probability of a positive outcome for an instance i, given a feature vector for the instance i and an action for the instance i, is denoted by

P(Yᵢ|Aᵢ=a, Xᵢ=x),

the goal of an ensemble of an embodiment could be to determine a predicted action a*(x) for Aᵢ that maximizes the probability as follows:

$${a}^{*} ( x ) = {argmax}_{a ∈ Å} P ( {Y}_{i} \vert {A}_{i} = a , {X}_{i} = x ) .$$

20

Such an ensemble may, for example, be utilized in an online advertisement-click system that controls the format of an advertisement. For illustrative purposes, assume Yᵢ=1 if a user i clicks on an online advertisement, and Yᵢ=0 if the user i does not click on the online advertisement. For each user viewing the online advertisement, we may have a set of feature values (e.g., an input feature vector) Xᵢ, which could correspond to such features as a user's client device operating system, a user's web browser type, or a user's geographic location (e.g., based on a network address lookup). Given a set of k possible advertisement formats Å={a₁, . . . , aₖ} for the online advertisement, an ensemble of an embodiment may determine a predicted advertisement format a*(x) (e.g., optimal or best advertisement format) for each user.

According to some embodiments, an ensemble of decision trees is generated (e.g., built or constructed) through a guided optimization of a split criterion at least defined by:

S(( [symbol] , [symbol] ); P)=C(P)−[C( [symbol] )+C( [symbol] )]

where [symbol] represents the left set of instances, where [symbol] represents the right set of instances, where P represents the particular set of instances such that P= [symbol] U [symbol] , where for k number of actions,

C(U)=φ(r₀(U)+1)φ(r₁(U)+1)−φ(N(U)+1)+Σᵢ₌₁^{k}φ(cᵢ(U)+1)−φ(a₀ᵢ(U)+1)−φ(a₁ᵢ(U)+1),

where φ represents a log function, where U represents the contingency table associated with the particular non-leaf node, where rᵢ(U) represents a sum of row i, cⱼ(U) represents a sum of column i (e.g., the total number of times action j appeared across all instances), where aᵢⱼ(U) represents an entry of the contingency table U at row i, column j, and where N (U) represents a sum of row sums and column sums. The log function may comprise the log-gamma function. For some embodiments, a criterion for selecting an optimal split, from a set of possible splits determined using the split criterion, is at least defined by:

$$( {ℒ}^{*} , {ℛ}^{*} ) = {argmax}_{( ℒ , ℛ )} S ( ( ℒ , ℛ ) ; P ) ,$$

where [symbol] * represents the left set of instances according to the optimal split, and where [symbol] * represents the right set of instances according to the optimal split. Additionally, for some embodiments, a non-leaf node is designated a leaf node if the optimal split satisfies a condition at least defined by:

S(( [symbol] , [symbol] ); P)<0.

During generation of a decision tree of the ensemble, a contingency table of action-outcome value pairs may be generated for, and subsequently associated with, each node in the decision tree based on feature values, action values, and outcome values of one or more instances associated with the node. The contingency table may comprise a 2×k contingency table for k possible action values. For example, the contingency table may be similar to Table 1.

TABLE 1

| | | | | | |
|---|---|---|---|---|---|
| Y = 0 | a₀₁ | a₀₂ | . . . | a₀ₖ | r₀ |
| Y = 1 | a₁₁ | a₁₂ | . . . | a₁ₖ | r₁ |
| | c₁ | c₂ | . . . | cₖ | N |

In the foregoing contingency table, rᵢ represents a sum of row i, cⱼ represents a sum of column i, and a_{i,j} represents an entry of the contingency at row i, column j.

For example, an embodiment may be applied to an industrial machine use case (e.g., wind turbine, jet engine, generator, etc.) such that Y=1 represents a favorable/desirable outcome of the industrial machine not failing within a certain period of time (e.g., 1 month), and Y=0 represents a less than favorable/desirable outcome of the industrial machine failing within the certain period of time. For such a use case, each aᵢⱼ in the contingency table can represent different actions that can be taken with respect to the industrial machine such as, for example: periodically running diagnostics on the industrial machine; shutting down the industrial machine for periods of time; replacing one or more components of the industrial machine at a specific interval; performing specific maintenance on the industrial machine; adjusting settings of the industrial machine; and the like.

In another user case, the industrial machine may already be damaged or non-operational, Y=1 could represent a favorable/desirable outcome of the industrial machine being operational again within a certain period of time (e.g., within 24 hours), and Y=0 could represent a less than favorable/desirable outcome of the industrial machine failing to be operation within the certain period of time. For such a use case, each aᵢⱼ in the contingency table can represent different repair actions that can be performed with respect to the industrial machine such as, for example, replacement of one or more components of the industrial machine or, alternatively, repair of one or more components of the industrial machine.

As a decision tree grows deeper when learning a decision tree, there can be significantly fewer actions involved in a split, e.g., more entries in the dense contingency tables are zero. A dense contingency table may be maintained for the instances on the left side of the split, the instances on the right side of the split, and the union of the left side and the right side. A lookup-table of actions that are active (e.g., non-zero) may be maintained for each of these dense contingency tables. When evaluating C(U), actions not involved in the left or right side of the split may be excluded from the computation. For some embodiments, this greatly reduces the time to evaluate the splitting criteria during the process of optimizing a splitting function.

Once generated based on historical data, an ensemble of an embodiment can be used to make a prediction about which action should be taken, given a set of feature values (e.g., an input feature vector) of a particular instance, to achieve a desired outcome for the particular instance. Specifically, the set of feature values can be processed by each decision tree in the ensemble. When processing the set of feature values by a decision tree of the ensemble, the decision tree can be traversed, from the root non-leaf node to a leaf node, by applying split niles implemented by non-leaf nodes of the decision tree, to the set of feature values. The split rule of a non-leaf node of a decision tree can determine whether to travel from a parent non-leaf node to a right node coupled to the parent non-leaf node or a left node coupled to the parent non-leaf node. As described herein, for decision trees of an ensemble, a particular leaf node can comprise a contingency table of action-outcome value pairs that corresponds to all instances, from historical data, that were associated (e.g., fell into the leaf node) with the leaf node during construction of the ensemble,

For example, let Aₜ (x) be the contingency table when applying the decision tree t in the ensemble to a feature vector X. Table 2 and Table 3 each represent an example contingency table that may be stored in association with a leaf node of a particular decision tree of an ensemble.

TABLE 2

| | a₁ | a₂ | a₃ | Total |
|---|---|---|---|---|
| Y = 0 | 7 | 7 | 2 | 16 |
| Y = 1 | 24 | 9 | 22 | 55 |
| Total | 31 | 16 | 24 | 71 |

TABLE 3

| | a₁ | a₂ | a₃ | Total |
|---|---|---|---|---|
| Y = 0 | 5 | 35 | 29 | 69 |
| Y = 1 | 12 | 65 | 29 | 106 |
| Total | 17 | 100 | 58 | 175 |

Assuming Y=1 represents a desired outcome to be achieved by an action predicted using an ensemble, a first leaf node associated with a contingency table similar to Table 2 would predict an action value of a₃ since the action value of a₃ is associated with the highest portion of 1s (22/24) in the first leaf node's contingency table. A second leaf node associated a contingency table similar to Table 3 would predict an action value of a₁ since the action value of a₁ is associated with the highest portion of 1s (12/17) in the second leaf node's contingency table.

Upon processing a set of feature values by each decision tree in an ensemble, an embodiment may determine a score (e.g., representing a number of votes, a score, or a probability) for each different action value predicted by the leaf nodes of decision trees in the ensemble. For instance, determining score for different action values may comprise determining a probability for each different action value in a contingency table using the following:

$$P ( {a}_{j} \vert {x}_{i} ) = \frac{1}{T} ( {\sum }_{t = 1}^{T} \frac{{a}_{j 1}^{t}}{{a}_{j 0}^{t} + {a}_{j 1}^{t}} ) .$$

In another instance, determining score for different action values may comprise determining a probability for each different action value in a contingency table using the following:

$$P ( {a}_{j} \vert {x}_{i} ) = \frac{{\sum }_{t = 1}^{T} {a}_{j 1}^{t}}{{\sum }_{t = 1}^{T} {a}_{j 0}^{t} + {a}_{j 1}^{t}} .$$

Both of these approaches to determining a probability may be considered analogous to node histogram aggregation. Depending on the embodiment, an ensemble processing a set of feature values may output a set of counts (e.g., representing a number of votes, a score, or a probability) for each different action value predicted by the decision trees of the ensemble. Alternatively, or additionally, an ensemble processing a set of feature values may output a predicted action having the largest count (e.g., most number of votes, highest score, or highest probability). The predicted action may represent an optimal or best action for achieving a desired outcome given the set of feature values.

Selecting Actions

The following discusses methods for selecting actions using a trained decision ensemble. Depending on the embodiment, there may be several methods for predicting an action that attempts to maximize the probability of a favorable or desired outcome. Two such methods include one that looks at contingency ratios and another that optimizes binomial Z-scores. As used herein, a contingency ratio score (e.g., Q^{MR} (aⱼ|x)) or a binomial Z-score Q^{MZ}(aⱼ|x)) calculated for an action can represent its confidence level. Both of these methods first traverse each decision tree with index t in the decision ensemble to obtain a leaf node. A contingency table for that leaf node in the context of a feature vector x applied to decision tree with index t may be denoted herein as a^{t}. As noted herein, the contingency table embedded in this leaf node may be the primary data structure used for selecting the action.

Maximum Contingency Ratio Prediction Method (MaxRatio)

For some embodiments, a maximum contingency ratio prediction method (MaxRatio) predicts an action a* by taking the largest ratio across the sum of contingency tables in the leaf nodes predicted by the decision ensemble on the feature vector x:

$${a}^{*} ( x ) = {argmax}_{j} \frac{{\sum }_{t = 1}^{T} {a}_{j 1}^{t}}{{\sum }_{t = 1}^{T} {a}_{j 0}^{t} + {a}_{j 1}^{t}} .$$

The action a* can represent the action having the highest confidence.
A MaxRatio score for an action aⱼ may be given by:

$${Q}^{MR} ( {a}_{j} \vert x ) = \frac{{\sum }_{t = 1}^{T} {a}_{j 1}^{t}}{{\sum }_{t = 1}^{T} {a}_{j 0}^{t} + {a}_{j 1}^{t}} .$$

Maximum Contigency Binomial Z-Score Prediction Method (MaxBZScore)

For some embodiments, a score for an action using a contingency Binomial Z-score prediction method (BZScore) method is given by:

$${Q}^{MR} ( {a}_{j} \vert x ) = {( \frac{q ( 1 - q )}{{n}_{i}} )}^{- 1 / 2} ( \frac{( {\sum }_{t = 1}^{T} {a}_{j 1}^{t} ) + 2}{{n}_{i} + 4} - q ) , \\ where {n}_{j} = {\sum }_{t = 1}^{T} {a}_{j 0}^{t} + {a}_{j 1}^{t} and q = \frac{{\sum }_{t = 1}^{T} {a}_{j 1}^{t}}{{\sum }_{t = 1}^{T} {n}_{i}} .$$

The BZScore method may predict the action with the highest binomial Z-score. For some embodiments, the action selected with a maximum contingency binomial Z-score prediction method (MaxBZScore) method comprises B

a*(x)=argmaxⱼQ^{MZ}(aⱼ|x).

The action a* can represent the action having the highest confidence.

Out-of-Bag Action Importances

For some embodiments, out-of-bag action importances R approximate how much a feature column in contributes to an action j having a desired outcome on unseen data. It may comprise a M by k matrix, where M is the number of dimensions in the feature vectors. Two variants are considered: one based on the contingency ratios (OOB-Ratio) and the other based on Binomial Z-scores (OOB-BinomialZ Score).

The action importance for action aⱼ and feature column (OOB-Ratio method) may be computed by:

$${R}_{m}^{MR} ( {a}_{j} \vert x ) = \frac{{Q}^{MR} ( {a}_{j} \vert {x}^{( m )} ) - {Q}^{MR} ( {a}_{j} \vert x )}{T} ,$$

where x^{(m)} is a feature vector where the m′th feature is randomly permuted. This effect in practice may be achieved by flipping a coin weighted by the proportions of training instances the fell into the left versus the right children when a non-leaf node is visited involving feature m.

The foregoing novel decision forest technology may optionally be employed as part of a broader industrial analytics platform to improve identification of issues and predictive modeling of assets. In further embodiments, the decision forest technology may further be used in connection with industrial digital twins, or digital models of industrial assets, to evaluate the operation of an asset based on received data and to analyze the impact of various actions or sets of actions. The present disclosure may, however, be embodied in many different forms and should not be construed as being limited to the embodiments set forth herein.

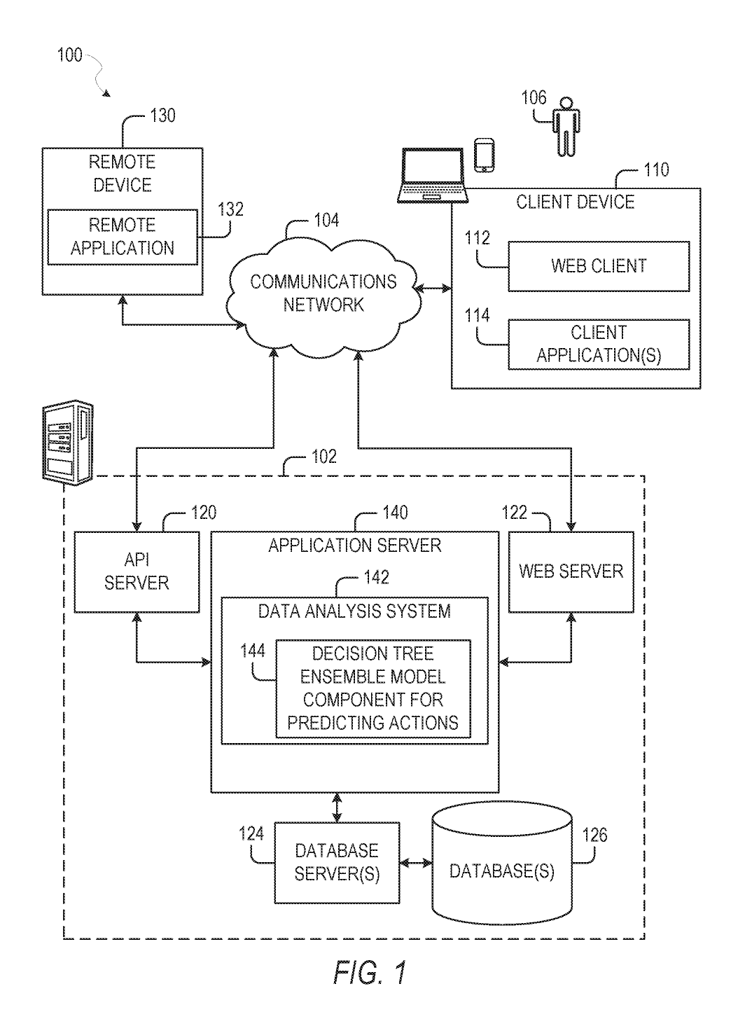

FIG. 1 is a block diagram illustrating an example networked system 102 including a decision tree ensemble model component 144 for predicting actions, in accordance with some embodiments of the present disclosure. According to some embodiments, the decision tree ensemble model component 144 is generated or used by a system or method described herein. For instance, the decision tree ensemble model component 144 may be generated based on historical data comprising, with respect to one or more prior instances, one or more observed feature values, observed action values, and observed outcome values. The historical data may be stored on a database or a formatted computer file used to store such historical data for subsequent use, such as training a decision tree ensemble model. The resulting decision tree ensemble model component 144 may be considered to be trained on the historical data. In another instance, the decision tree ensemble model component 144 may process a set of feature values as input and generate, as output, a predicted action to achieve a desired outcome based on the set of feature values.

With reference to FIG. 1, an embodiment of a high-level client-server-based network architecture 100 is shown. As shown, the network architecture 100 includes the networked system 102, a client device 110, one or more remote devices 130, and a communications network 104 facilitating data communication therebetween. The networked system 102 provides server-side data analysis functionality, via the communications network 104, to one or more client devices 110. FIG. 1 illustrates, for example, a web client 112, such as a web browser, and a client application 114 executing on the client device 110.

As also shown, the networked system 102 includes a data analysis system 142 comprising the decision tree ensemble model component 144. The data analysis system 142 may use the decision tree ensemble model component 144 to analyze data from industrial devices, such as generators, wind turbines, medical devices, jet engines, and locomotives, and predict (e.g., selecting) actions to be performed with respect to those industrial devices, such as actions relating to maintenance, repairs, or operations. The desired effect of performing such predicted actions may include, for example, ensuring efficient, continuous, or proper operation of industrial devices. By way of the data analysis system 142, the networked system 102 can form an industrial device data analysis software platform. This industrial device data analysis software platform can include a collection of software services and software development tools, which enable a user (e.g., an industrial customer) to use, or develop and use, applications for optimizing industrial business processes with respect to industrial devices.

In FIG. 1, the remote device 130 may represent an industrial device that includes a remote application 132 to collect data from the remote device 130, such as sensor data, diagnostic data, or performance data. The collected data may comprise event logs, error logs, time-series data, and the like. The collected data may be included by input data (e.g., input feature vector) to the decision tree ensemble model component 144, which can cause the decision tree ensemble model component 144 to generate a predicted action (e.g., repair, maintenance, or preventative action with respect to an industrial machine) for achieving a desired outcome (e.g., ensuring that the industrial machine remains operation for the next two months) based on the input data (e.g., at least some portion of the collected data). In this way, the input data to the decision tree ensemble model component 144 provides to the decision tree ensemble model component 144 the context in which the remote device 130 is operating. Subsequently, the predicted action can be provided by the data analysis system 142 to a user 106 at the client device 110, such as through the web client 112 or the client application 114.

The client device 110 may comprise, but is not limited to, a mobile phone, desktop computer, laptop, portable digital assistant (PDA), smart phone, tablet, ultrabook, netbook, laptop, multi-processor system, microprocessor-based or programmable consumer electronics system, game console, set-top box (STB), or any other communication device that a user may utilize to access the networked system 102. In some embodiments, the client device 110 comprises a display module (not shown) to display information, such as in the form of user interfaces. In further embodiments, the client device 110 comprises one or more touch screens, accelerometers, gyroscopes, cameras, microphones, global positioning system (GPS) devices, and so forth. The client device 110 ay be a device of a user that is used to access data analysis or industrial applications supported by the networked system 102. One or more users 106 may be a person, a machine, or other means of interacting with the client device 110. In embodiments, the user 106 is not part of the network architecture 100, but interacts with the network architecture 100 via the client device 110 or another means. For example, one or more portions of the communications network 104 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched. Telephone Network (PSTN), a cellular telephone network, a wireless network, a Wi-Fi® network, a WiMax network, another type of network, or a combination of two or more such networks.

The client device 110 may include one or more applications such as, but not limited to, a business or industrial application supported by the data analysis system 142. In some embodiments, the business or industrial application is included in one of the client devices 110, and the application is configured to locally provide the user interface and at least some of the functionalities to communicate with the networked system 102, on an as-needed basis, for data or processing capabilities not locally available. Conversely, in some embodiments, the business or industrial application is not included in the client device 110, and the client device 110 may use its web browser to access the business or industrial application (or a variant thereof) hosted on the networked system 102.

As noted herein, in embodiments, the user 106 is not part of the network architecture 100, but may interact with the network architecture 100 via the client device 110 or other means. For instance, the user 106 provides input to the client device 110 and the input is communicated to the networked system 102 via the communications network 104. In this instance, the networked system 102, in response to receiving the input from the user 106, communicates information to the client device 110 via the communications network 104 to be presented to the user 106. In this way, the user 106 can interact with the networked system 102 using the client device 110.

An application programming interface (API) server 120 and a web server 122 are coupled to, and provide programmatic and web interfaces respectively to, one or more application servers 140. As shown, the application server 140 hosts the data analysis system 142, which, in addition to the decision tree ensemble model component 144, may include one or more additional modules, each of which may be embodied as hardware, software, firmware, or some combination thereof.

The application server 140 is shown to be coupled to one or more database servers 124 that facilitate access to one or more information storage repositories or databases 126. In an embodiment, the databases 126 are storage devices that store information, such as data generated and collected from an industrial device to be analyzed by the data analysis system 142.

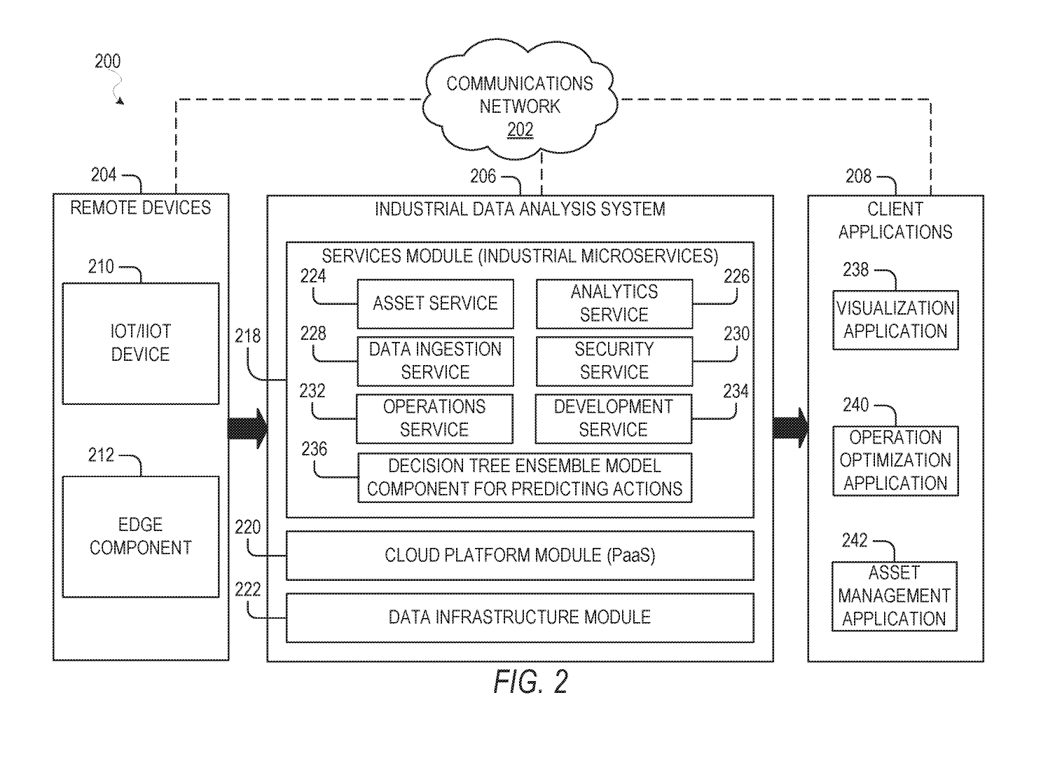

FIG. 2 is a block diagram illustrating an example system 200 including a decision tree ensemble model component 236 for predicting actions, in accordance with some embodiments of the present disclosure. As shown, the system 200 includes remote devices 204, an industrial data analysis system 206, one or more client applications 208, and a communications network 202 to facilitate data communication therebetween. The remote devices 204 can represent any device that can collect data regarding itself and provide the collected data to the industrial data analysis system 206 to perform analysis and other operations, such as those using the decision tree ensemble model component 236. The collected data may comprise event logs, error logs, time-series data, and the like. As shown, the remote devices 204 include an IoT or Industrial IoT (IIoT) device 210 and an edge component 212, such as an IoT/IIoT gateway, device controller, or sensor node.

For some embodiments, the industrial data analysis system 206 represents a machine-learning, data analysis platform, such as Predix®, which may use the decision tree ensemble model component 236 to process a set of feature values based on, regarding, or including data provided by the remote device 204, such as device make, device model, event logs, error logs, and time-series data. The client applications 208 may represent those applications that use functions of, or data results generated by, the industrial data analysis system 206. As shown, the client applications 208 include a visualization application 238, an operation optimization application 240, and an asset management application 242, such as an industrial device software application.

The industrial data analysis system 206 includes a services module 218, a cloud platform module 220, and a data infrastructure module 222. The industrial data analysis system 206 can include a collection of software services and software development tools, which enable a user (e.g., an industrial customer) to use, or develop and use, applications for optimizing industrial business processes with respect to industrial devices. For instance, the industrial data analysis system 206 can monitor IIoT devices, digest data from such devices, analyze the digested data using services (e.g., microservices) provided by the services module 218, and make predictions using machine-learning (ML) implemented by one or more services of the services module 218.

The services module 218 can provide various industrial services that a development user can use to build an industrial software application or pre-built software services (e.g., from a third-party vendor). As shown, the services module 218 includes an asset service 224, an analytics service 226, a data ingestion service 228, a security service 230, an operations service 232, a development service 234, and the decision tree ensemble model component 236. The asset service 224 may facilitate creation, importation, and organization of industrial device/asset models and associated business rules. The analytics service 226 may facilitate creation, cataloging, or orchestration of analytics on industrial devices, which can serve as a basis for industrial applications, such as the client applications 208. The data ingestion service 228 can facilitate ingestion, formatting, merging, or storage of data from an industrial device. The security service 230 may facilitate end-to-end security, authentication, or authorization between the industrial data analysis system 206 and other entities within the system 200. The operations service 232 may facilitate control and operation of industrial devices. The development service 234 may facilitate the development of industrial applications, by a development user, using the industrial data analysis system 206.

The cloud platform module 220 may comprise a cloud framework that enables various functions of the industrial data analysis system 206 to be built, or operated, as cloud-based services, such as a platform-as-a-service (PaaS).

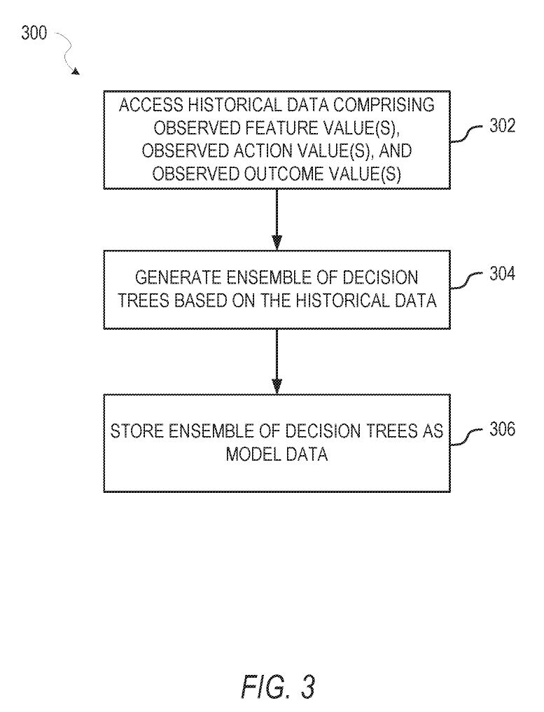

FIG. 3 is a flow chart illustrating an example method 300 for generating a decision tree ensemble for predicting an action, in accordance with some embodiments of the present disclosure. For some embodiments, operations of the method 300 may be performed by one or both of a model machine and a prediction machine. An operation of the method 300 may be performed by a hardware processor, such as a central processing unit (CPU) or graphics processing unit (GPU), of a computing device, such as a desktop, laptop, server, or the like.

As shown in FIG. 3, the method 300 begins at operation 302 accessing historical data for a set of instances. According to some embodiments, for a particular instance (e.g., for each particular instance) in the set of instances, the historical data comprises a set of observed feature values for a set of features, an observed action value, and an observed outcome value for the observed action value. The historical data may be accessed from a database or a formatted computer file used to store such historical data for subsequent use, such as training a decision tree ensemble model. The historical data, for example, may be observed (e.g., collected) from one or more devices involved in actions and outcomes resulting from the actions. The observed action value may comprise one of a predetermined plurality of possible action values. Additionally, as described herein, the ensemble of an embodiment may involve a binary outcome, where the values of 1 and 0 may respectively represent the two possible outcomes. For example, a value of 1 may represent an outcome of positive classification and a value of 0 represent an outcome of negative classification. Accordingly, the observed outcome values may comprise one of two predetermined possible outcome values.

The method 300 continues with operation 304 generating an ensemble of decision trees based at least in part on the historical data such that for each given leaf node of decision trees in the ensemble, the given leaf node is associated with a contingency table of action-outcome value pairs. According to some embodiments, the contingency table associated with the given leaf node is generated based at least in part on the set of observed feature values, the observed action value, and the observed outcome value for a given set of instances associated with the given leaf node, where the given set of instances is included in the set of instances. As a result, a contingency table of a particular leaf node may aggregate action-outcome value pairs of an instance associated with the particular leaf node. For some embodiments, during generation of a decision tree of the ensemble, a contingency table is generated for each particular node of the decision tree and the contingency table generated for the particular node is used by a split criterion to determine possible splits for the set of instances associated with each node. The contingency table may comprise a 2×k contingency table, where k represents number of different action values. An ensemble of an embodiment may select the predicted action from the k different values. Depending on the embodiment, associating the particular decision tree node with the contingency table may comprise storing the contingency table in association with the particular decision tree node, which can include storing the contingency table, or an association thereto, within a data structure representing the particular decision tree node. Three vectors of the same length may also be stored in each leaf node to represent the (outcome i, action j, multiplicity a_ij) tuples where a_ij>0.

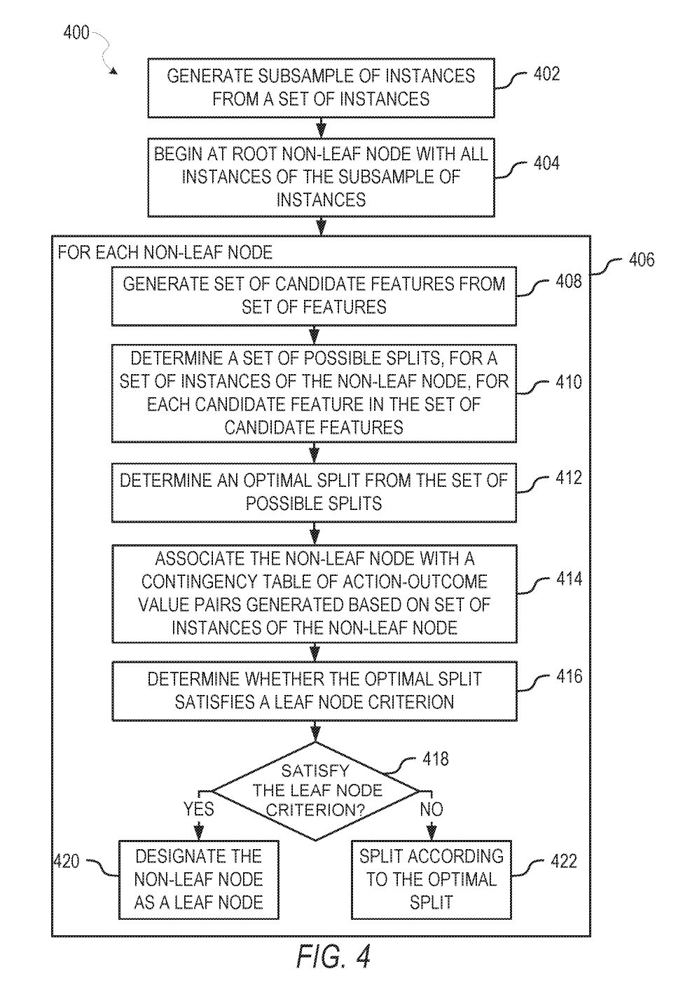

For some embodiments, operation 304 generates the ensemble of decision trees based at least in part on the historical data and by using a split criterion at least defined by; S(( [symbol] , [symbol] ); P)=C(P)−[C( [symbol] )+C( [symbol] )], as described herein. Additionally, for some embodiments, operation 304 generates the ensemble of decision trees based at least in part on the historical data, according to a method 400 as described herein with respect to FIG. 4.

The method 300 continues with operation 306 storing the ensemble of decisions trees, generated by operation 304, as model data for subsequent (e.g., future) access and use the ensemble of decision trees, such as by the computing device that performing the method 300 or another computing device that receives the ensemble of decision trees (e.g., as part of a deployment). The operation 306 may store the model data to a database or a formatted computer file.

FIG. 4 is a flow chart illustrating the example method 400 for generating a decision tree of a decision tree ensemble for predicting an action, in accordance with some embodiments of the present disclosure. In particular, the method 400 may be used to generate individual decision trees in the ensemble. According to some embodiments, the method 400 is used to generate each decision tree in the ensemble. For such embodiments, if an ensemble of an embodiment is to comprise p number of decision trees, the method 400 is performed p number of times to generate those decision trees. For some embodiments, operations of the method 400 may be performed by one or both of a model machine and a prediction machine. An operation of the method 400 may be performed by a hardware processor of a computing device.

As shown in FIG. 4, the method 400 begins with operation 402 generating a subsample of instances from a set of instances. According to some embodiments, the set of instances is provided by historical data that comprises, for each instance in the set of instances, a set of observed feature values for a set of features, an observed action value, and an observed outcome value for the observed action value. The subsample of instances may be generated using a sampling technique, such as sampling n instances from the set of instances with replacement, or another sampling technique used in building decision forests. For some embodiments, the subsample of instances generated by operation 402 comprise those instances that will be used to generate a particular decision tree of the ensemble, and other subsamples of instances are generated and then used when generating other decision trees of the ensemble.

The method 400 continues with operation 404 beginning generation of a particular decision tree based on the subsample of instances generated by operation 402. In particular, operation 404 begins generating the particular decision tree, at a root non-leaf node of the particular decision tree, with all instances of the subsample of instances. As such, the root non-leaf node of the particular decision tree is associated with all instances of the subsample.

The method 400 continues with operation 406 performing sub-operations 408-422 for each non-leaf node of the particular decision tree, and doing so until each non-leaf node of the particular decision tree is operated on by operation 406 at least once. As shown, operation 406 begins with sub-operation 408 generating a set of candidate features from a set of features. For example, where the set of features comprises p features X₁, . . . , Xₚ, sub-operation 408 may sample in candidate features from X₁, . . . , Xₚ, where m<p. The set of candidate features may represent one or more features of interest with respect to the current non-leaf node being operated upon by operation 406.

The method may maintain a multivariate cache to store data needed to learn a decision tree. The actions and outcomes of instances of the subsample for a decision tree may be stored in this cache.

With respect to the current non-leaf node of operation 406, operation 406 continues with sub-operation 410 determining, for each particular candidate feature in the set of candidate features generated by sub-operation 408, a set of possible splits for splitting (e.g., partitioning) a particular set of instances of the current non-leaf node into a left set of instances for a left non-leaf node and a right set of instances for a right non-leaf node. For the particular decision tree being generated by the method 400, the current non-leaf node would serve as a parent node to both the left non-leaf node and the right non-leaf node that would result from performing one of the possible splits.

Before considering a feature in the current leaf node, the feature values across all instances involved in the split may be stored in a multivariate cache. If a feature was previously explored, its feature data may be evicted from the multivariate cache.

According to some embodiments, determining the set of possible splits comprises generating contingency tables (e.g., 2×k contingency tables) that represent all possible splits of the particular set of instances. For some embodiments, generating the contingency tables comprises using tuples to represent feature value-action value-outcome value combinations, which may permit rapid generation of the contingency tables. Additionally, for some embodiments, generating the contingency tables with respect to corresponding to the set of possible splits to the current non-leaf node comprises starting the left node with a contingency table equal to the contingency table of the current (parent) non-leaf node, starting the right node with a contingency table that is empty, and then adjusting (e.g., incrementing and decrementing) entries in the contingency tables according to tuple values from the historical data as the generation process passes along the set of candidate features for the current non-leaf node.

As described herein, the determining the set of possible splits for the particular candidate feature, into the left set of instances and into the right set of instances, is based at least in part on a split criterion at least defined by:

S(( [symbol] , [symbol] ); P)=C(P)−[C( [symbol] )+C( [symbol] )],

where [symbol] represents the left set of instances, where [symbol] represents the right set of instances, and where P represents the particular set of instances such that P= [symbol] U [symbol] . Additionally, for k number of actions, C(U) may be defined by:

C(U)=φ(r₀(U)+1)+φ(r₁(U)+1)−φ(N(U)+1)+Σᵢ₌₁^{k}φ(cᵢ(U)+1) −φ(a₀ᵢ(U)+1)−φ(a₁ᵢ(U)+1),

where φ represents a log function, where U represents the contingency table associated with the particular non-leaf node, where rᵢ(U) represents a sum of row i, cⱼ (U) represents a sum of column i, where aᵢⱼ(U) represents an entry of the contingency table U at row i, column j and where N(U) represents a sum of row sums and column sums. The log function may comprise a log-gamma function.

With respect to the current non-leaf node, operation 406 continues with sub-operation 412 determining, from the set of possible splits generated by sub-operation 410, an optimal split for the particular set of instances. According to some embodiments, determining the optimal split from the set of possible splits is further based at least in part on an optimal split criterion at least defined by:

$$( {ℒ}^{*} , {ℛ}^{*} ) = {argmax}_{( ℒ , ℛ )} S ( ( ℒ , ℛ ) ; P ) ,$$

where [symbol] * represents the left set of instances according to the optimal split and where [symbol] * represents the right set of instances according to the optimal split.

With respect to the current non-leaf node of operation 406, operation 406 continues with sub-operation 414 associating the current non-leaf node with a contingency table of action-outcome value pairs generated based at least in part on the particular set of instances of the current non-leaf node. The contingency table of the current non-leaf node may have been generated in a prior operation that associated (e.g., assigned) the set of particular instances to the current non-leaf node. For instance, if the current non-leaf node is the root non-leaf node, the contingency table of the current non-leaf node may have been generated at operation 404. Where the current non-leaf node is a left or right node of another non-leaf node, the contingency table of the current non-leaf node may have been previously generated during performance of sub-operation 410 on the other non-leaf node.

With respect to the current non-leaf node of operation 406, operation 406 continues with sub-operation 416 determining whether the optimal split, determined by sub-operation 412, satisfies a leaf node criterion, According to some embodiments, the leaf node criterion specifies that the optimal split satisfies a condition at least defined by:

S(( [symbol] , [symbol] ); P)<0.

At 418, operation 406 continues to sub-operation 420 in response to sub-operation 416 determining that the optimal split does satisfy the leaf node criterion, and continues to sub-operation 422 in response to sub-operation 416 determining that the optimal split does not satisfy the leaf node criterion. With respect to the current non-leaf node of operation 406, operation 406 continues with sub-operation 420 designating the current non-leaf node to be a leaf node. With respect to the current non-leaf node of operation 406, operation 406 continues with sub-operation 422, splitting the particular set of instances, according to the optimal split determined by sub-operation 412, into the left set of instances and the right set of instances for the left and right nodes respectively.

Though the operations of the method 400, and other methods described herein, may be depicted and described in a certain order, the order in which the operations are performed may vary between embodiments. For instance, an operation may be performed before, after, or concurrently with another operation. Additionally, components or machines described herein with respect to various methods are merely examples of components or machines that may be used with those methods, and other components or machines may also he utilized in some embodiments.

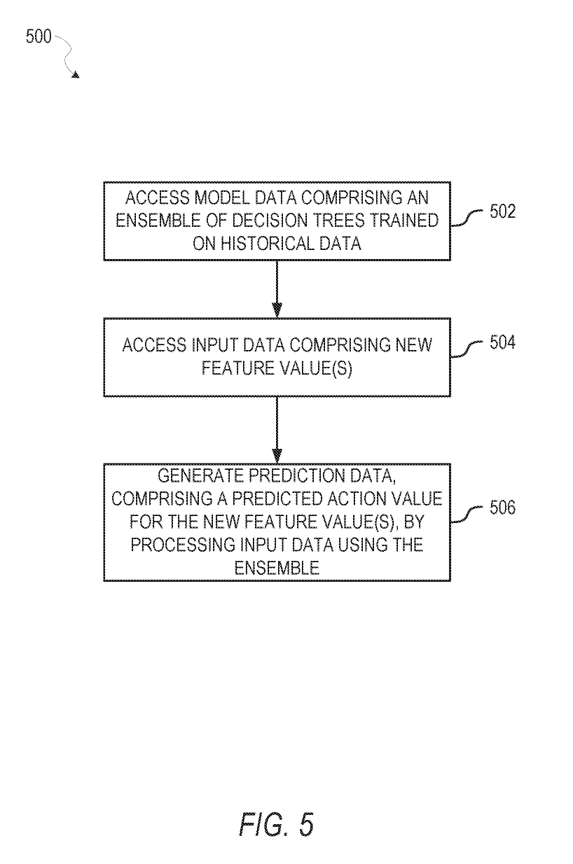

FIG. 5 is a flow chart illustrating an example method 500 for using a decision tree ensemble for predicting an action, in accordance with some embodiments of the present disclosure. For some embodiments, operations of the method 500 may be performed by one or both of a prediction machine, An operation of the method 400 may be performed by a hardware processor of a computing device.

As shown, the method 500 begins with operation 502 accessing model data comprising an ensemble of decision trees trained on historical data for a set of instances. According to some embodiments, for a particular instance in the set of instances, the historical data comprises a set of observed feature values for a set of features, an observed action value, and an observed outcome value for the observed action value. Additionally, for some embodiments, each leaf node of decision trees in the ensemble is associated with a contingency table of action-outcome value pairs generated based at least in part on the historical data.

The method 500 continues with operation 504 accessing input data comprising a set of new feature values for the set of features. As described herein, the set of new feature values may comprise values extracted from, or based on, data received from an industrial device, which could include such information as a device's make, a device's model, or device diagnostics.

The method 500 continues with operation 506 generating prediction data by processing the input data using the ensemble, the prediction data comprising a predicted action value for the set of new feature values. For some embodiments, generating the prediction data comprises determining (e.g., identifying) a set of particular contingency tables of action-outcome value pairs from leaf nodes of the decision trees in the ensemble, and determining the predicted action value for the set of new feature values by combining the set of particular contingency tables determined. The set of particular contingency tables may be determined by processing the set of new feature values, using each particular decision tree in the ensemble, to determine (e.g., identify) a particular contingency table of a leaf node of the particular decision tree. Processing the set of new feature values by a given decision tree of the ensemble can facilitate traversal from a root non-leaf node of the given decision tree to one of the leaf nodes of the given decision tree. The predicted action value would represent an action value predicted by the ensemble for the set of new feature values.

Some embodiments may implement a tree-histogram approach to combining the contingency tables. For example, combining the set of particular contingency tables may comprise determining a set of counts for one or more different action-outcome value pairs by determining a count for each different action-outcome value pair in the set of particular contingency tables, and selecting the predicted action value, from the one or more different action-outcome value pairs, based at least in part on the set of counts. The set of counts may be determined by summing the contingency tables, which would combine the counts of all action-outcome value pairs. The predicted action value selected may represent the action that minimizes a loss function over the combined contingency table that results. For a simple loss function where Y=1 is scored as 0 and Y=0 is scored as 1, the predicted action value that minimizes the loss function may be the one that leads to the highest portion of is in the combined contingency table.

Some embodiments may implement a tree-level-voting approach to combining the contingency tables. For example, combining the set of particular contingency tables may comprise determining a set of best action values for the set of particular contingency tables by determining, for each given contingency table in the set of particular contingency tables, a best action value voted for by a given decision tree in an ensemble based at least in part on the given contingency table associated with the given decision tree. Subsequently, a set of counts for one or more different action values may be determined by determining a count for each different action value in the set of best action values, and the predicted action value may be selected, from the one or more different action values, based at least in part on the set of counts. The set of counts may represent each decision tree's vote for a particular action value. According to some embodiments, each decision tree in the ensemble votes for a predicted action value (e.g., optimal or best action value) according to a loss function over the possible outcome values. Again, for a simple loss function where Y=1 is scored as 0 and Y=0 is scored as 1, the predicted action value may be the one that minimizes the loss function by maximizing the number of Y=1 outcomes. After each decision tree in the ensemble votes for a predicted action value, the predicted action value of the ensemble may be the one that receives the most votes.

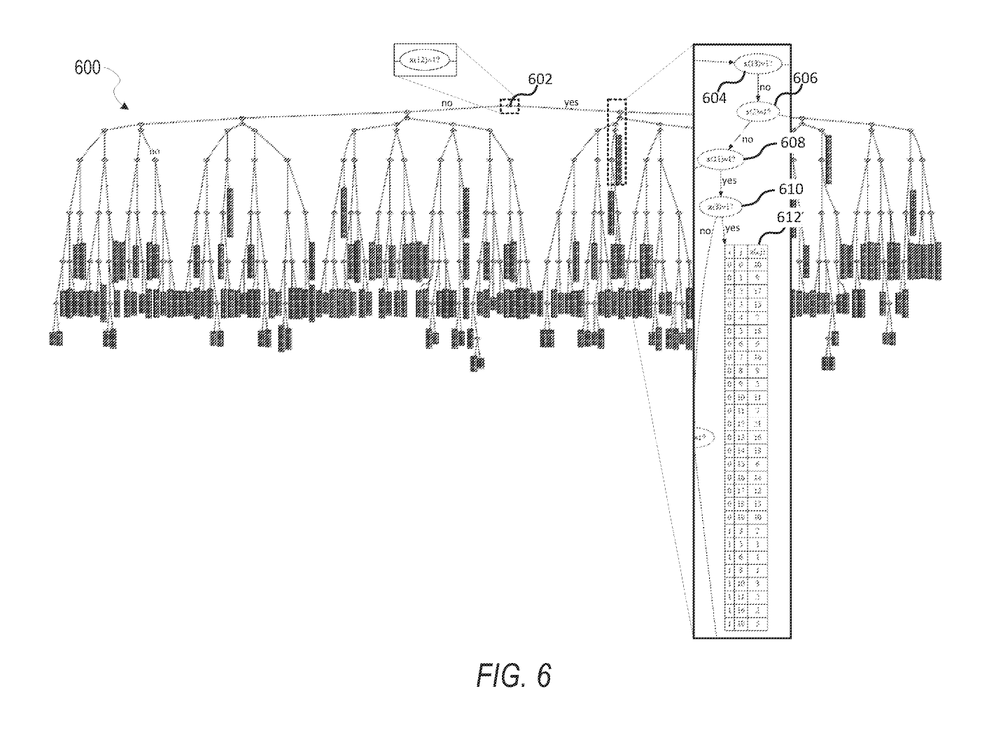

FIG. 6 is a diagram illustrating an example decision tree ensemble 600 for predicting an action, in accordance with some embodiments of the present disclosure. In particular, the decision tree ensemble 600 represents a decision tree ensemble that was generated based on historical data (e.g., historical data collected from an industrial machine) and that can be subsequently accessed to generate prediction data (e.g., predicted action to achieve favorable/desirable outcome) in accordance with various embodiments described herein. As shown, the decision tree ensemble 600 comprises a plurality of non-leaf nodes and a plurality of leaf-nodes that are each associated with a contingency table. As illustrated by example contingency table 612, each contingency table includes a column i that corresponds to outcome values, column j that corresponds to action values, and column a(i,j) that corresponds to the multiplicity for the pair. The x(k) can represent a kth (e.g., k>0) binary feature in a feature vector x. When a particular feature vector xᵢ is be processed using the decision tree ensemble 600, an embodiment may use the feature vector xi to traverse from a root node 602 of the decision tree ensemble 600 to a leaf node associated with a contingency table (e.g., 612), which can be subsequently used to generate prediction data (e.g., predict an action that results in a favorable or desirable outcome).

For instance, an example feature vector xₑ=<0,0,1,1,1,0,1,0,1,0,1,1,0,0,1,1,1,0> may be processed by the decision tree ensemble 600. Each of the binary features in the example feature vector xₑ may, for example, represent a different attribute or characteristic of a particular industrial machine (e.g., wind turbine, jet engine, or generator), where the attribute or characteristic (e.g., operational, non-operational, fault present, degraded performance, etc.) can be represented by a binary value (e.g., 1 or 0). Such attributes or characteristics of the particular industrial machine can be derived from data collected from the particular industrial machine (e.g., diagnostic data). The outcome value i=1 can represent the favorable/desirable outcome with respect to the industrial machine (e.g., remains operational for the next two months), while the outcome value i=0 can represent a less than favorable/desirable outcome with respect to the industrial machine (e.g., does not remain operational for the next two months). Based on the example feature vector xₑ described above, a process can traverse from the root node 602 to node 604 because xₑ(12)=1, traverse from node 604 to node 606 because xₑ(13)≠1, traverse from node 606 to node 608 because xₑ(2)≠1, traverse from node 608 to node 610 because xₑ(11)=1, and traverse from node 610 to a leaf node associated with the contingency table 612 because xₑ(3)=1. Based on the contingency table 612, an embodiment as described herein may predict that a particular action value j can best achieve the favorable/desired outcome value of i=1.

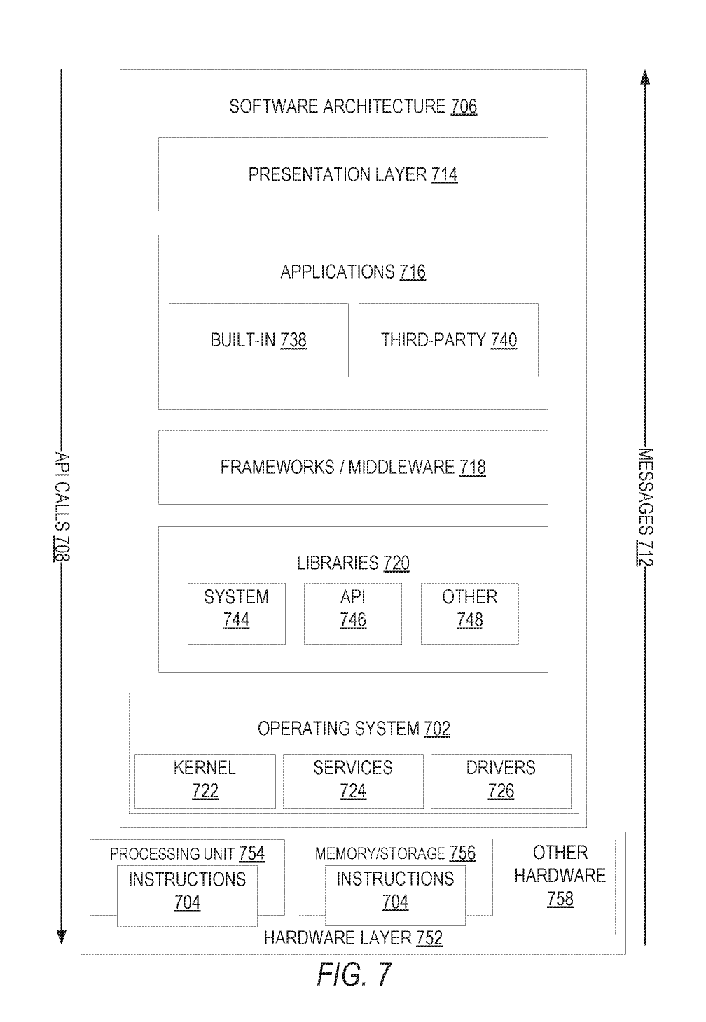

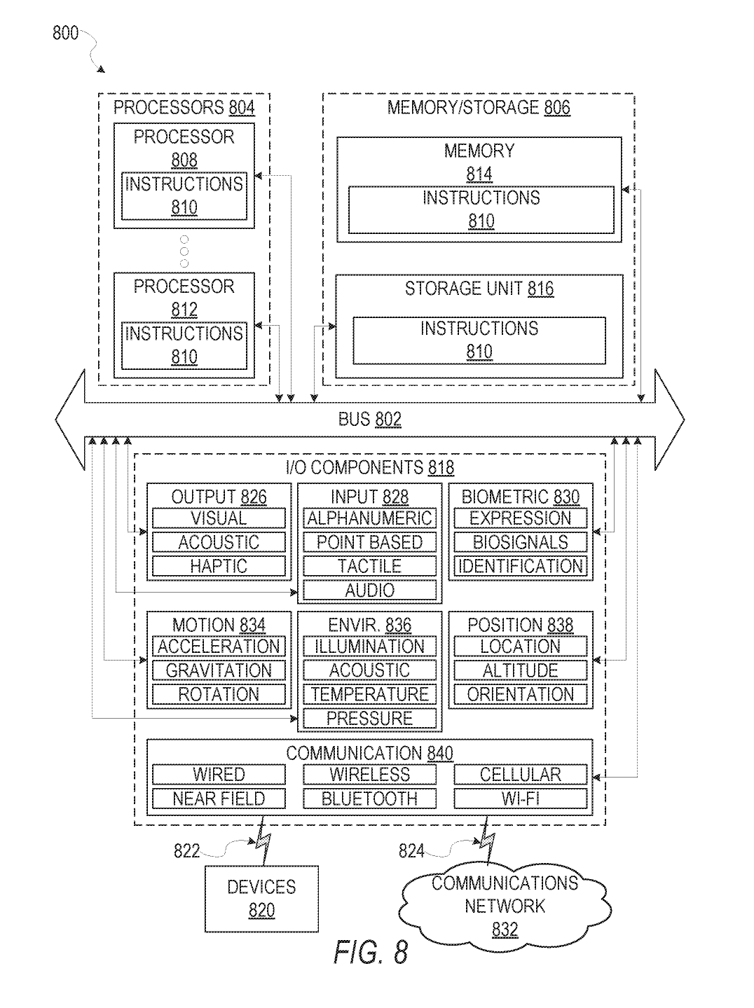

Various embodiments described herein may be implemented by way of the example software architecture illustrated by and described with respect to FIG. 7 or by way of the example machine illustrated by and described with respect to FIG. 8.

FIG. 7 is a block diagram illustrating an example software architecture 706, which may be used in conjunction with various hardware architectures herein described. FIG. 7 is a non-limiting example of a software architecture and it will be appreciated that many other architectures may be implemented to facilitate the functionality described herein. The software architecture 706 may execute on hardware such as a machine 800 of FIG. 8 that includes, among other things, processors 804, memory 814, and input/output (I/O) components 818. A representative hardware layer 752 is illustrated and can represent, for example, the machine 800 of FIG. 8. The representative hardware layer 752 includes a processing unit 754 having associated executable instructions 704. The executable instructions 704 represent the executable instructions of the software architecture 706, including implementation of the methods, components, and so forth described herein. The hardware layer 752 also includes memory and/or memory/storage modules 756, which also have the executable instructions 704. The hardware layer 752 may also comprise other hardware 758.

In the example architecture of FIG. 7, the software architecture 706 may be conceptualized as a stack of layers where each layer provides particular functionality. For example, the software architecture 706 may include layers such as an operating system 702, libraries 720, frameworks/middleware 718, applications 716, and a presentation layer 714. Operationally, the applications 716 and/or other components within the layers may invoke API calls 708 through the software stack and receive messages 712 in response to the API calls 708. The layers illustrated are representative in nature and not all software architectures have all layers. For example, some mobile or special-purpose operating systems 702 may not provide a frameworks/middleware 718, while others may provide such a layer. Other software architectures may include additional or different layers.

The operating system 702 may manage hardware resources and provide common services. The operating system 702 may include, for example, a kernel 722, services 724, and drivers 726. The kernel 722 may act as an abstraction layer between the hardware and the other software layers. For example, the kernel 722 may be responsible for memory management, processor management (e.g., scheduling), component management, networking, security settings, and so on. The services 724 may provide other common services for the other software layers. The drivers 726 are responsible for controlling or interfacing with the underlying hardware. For instance, the drivers 726 include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 720 provide a common infrastructure that is used by the applications 716 and/or other components and/or layers. The libraries 720 provide functionality that allows other software components to perform tasks in an easier fashion than by interfacing directly with the underlying operating system 702 functionality (e.g., kernel 722, services 724, and/or drivers 726). The libraries 720 may include system libraries 744 (e.g., C standard library) that may provide functions such as memory allocation functions, string manipulation functions, mathematical functions, and the like. In addition, the libraries 720 may include API libraries 746 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 720 may also include a wide variety of other libraries 748 to provide many other APIs to the applications 716 and other software components/modules.

The frameworks/middleware 718 provide a higher-level common infrastructure that may be used by the applications 716 and/or other software components/modules. For example, the frameworks/middleware 718 may provide various graphic user interface (GUI) functions, high-level resource management, high-level location services, and so forth. The frameworks/middleware 718 may provide a broad spectrum of other APIs that may be used by the applications 716 and/or other software components/modules, some of which may be specific to a particular operating system 702 or platform.

The applications 716 include built-in applications 738 and/or third-party applications 740. Examples of representative built-in applications 738 may include, but are not limited to, a contacts application, a browser application, a book reader application, a location application, a media application, a messaging application, and/or a game application. The third-party applications 740 may include an application developed using the Android™ or iOS™ software development kit (SDK) by an entity other than the vendor of the particular platform, and may be mobile software running on a mobile operating system such as iOS™, Android™, Windows® Phone, or other mobile operating systems. The third-party applications 740 may invoke the API calls 708 provided by the mobile operating system (such as the operating system 702) to facilitate functionality described herein.

The applications 716 may use built-in operating system functions (e.g., kernel 722, services 724, and/or drivers 726), libraries 720, and frameworks/middleware 718 to create user interfaces to interact with users of the system. Alternatively, or additionally, in some systems, interactions with a user may occur through a presentation layer, such as the presentation layer 714. In these systems, the application/component “logic” can be separated from the aspects of the application/component that interact with a user.

FIG. 8 is a block diagram illustrating components of an example machine 800, according to some embodiments, able to read instructions 810 from a machine storage medium and perform any one or more of the methodologies discussed herein. Specifically, FIG. 8 shows a diagrammatic representation of the machine 800 in the example form of a computer system, within which the instructions 810 (e.g., software, a program, an application, an applet, an app, or other executable code) for causing the machine 800 to perform any one or more of the methodologies discussed herein may be executed. As such, the instructions 810 may be used to implement modules or components described herein. The instructions 810 transform the general, non-programmed machine 800 into a particular machine 800 programmed to carry out the described and illustrated functions in the manner described. In alternative embodiments, the machine 800 operates as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine 800 capable of executing the instructions 810, sequentially or otherwise, that specify actions to be taken by that machine 800. Further, while only a single machine 800 is illustrated, the term “machine” shall also be taken to include a collection of machines 800 that individually or jointly execute the instructions 810 to perform any one or more of the methodologies discussed herein.

The machine 800 may include processors 804, memory/storage 806, and I/O components 818, which may be configured to communicate with each other such as via a bus 802. The processors 804 may comprise a single processor or, as shown, comprise multiple processors (e.g., processors 808 and 812). The memory/storage 806 may include a memory 814, such as a main memory, or other memory storage, and a storage unit 816, both accessible to the processors 804 such as via the bus 802. The storage unit 816 and memory 814 store the instructions 810 embodying any one or more of the methodologies or functions described herein. The instructions 810 may also reside, completely or partially, within the memory 814, within the storage unit 816, within at least one of the processors 804 (e.g., within the processor 808's cache memory), or any suitable combination thereof, during execution thereof by the machine 800. Accordingly, the memory 814, the storage unit 816, and the memory of the processors 804 are examples of machine storage media.

The I/O components 818 may include a wide variety of components to receive input, provide output, produce output, transmit information, exchange information, capture measurements, and so on. The specific I/O components 818 that are included in a particular machine 800 will depend on the type of machine. For example, portable machines such as mobile phones will likely include a touch input device or other such input mechanisms, while a headless server machine will likely not include such a touch input device. It will be appreciated that the I/O components 818 may include many other components that are not shown in FIG. 8. The I/O components 818 are grouped according to functionality merely for simplifying the following discussion and the grouping is in no way limiting. In various embodiments, the I/O components 818 may include output components 826 and input components 828. The output components 826 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms). Other signal generators, and so forth. The input components 828 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and/or force of touches or touch gestures, or other tactile input components), audio input components (e.g., a microphone), and the like.

In further embodiments, the I/O components 818 may include biometric components 830, motion components 834, environment components 836, or position components 838 among a wide array of other components. For example, the biometric components 830 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 834 may include acceleration sensor components (e.g., accelerometer), gravitation sensor components, rotation sensor components (e.g., gyroscope), and so forth. The environment components 836 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas sensors to detect concentrations of hazardous gases for safety or to measure pollutants in the atmosphere), or other components that may provide indications, measurements, or signals corresponding to a surrounding physical environment. The position components 838 may include location sensor components a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 818 may include communication components 840 operable to couple the machine 800 to a communications network 832 or devices 820 via a coupling 824 and a coupling 822, respectively. For example, the communication components 840 may include a network interface component or other suitable device to interface with the communications network 832. In further examples, the communication components 840 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 820 may be another machine or any of a wide variety of peripheral devices (e.g., a peripheral device coupled via a USB).

Moreover, the communication components 840 may detect identifiers or include components operable to detect identifiers. For example, the communication components 840 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 840, such as location via Internet Protocol (IP) geolocation, location via Wi-Fi® signal triangulation, location via detecting an NFC beacon signal that may indicate a particular location, and so forth.

It will be understood that “various components” (e.g., modules) used in this context (e.g., system components) refers to a device, a physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function or related functions. Components may constitute either software components (e.g., code embodied on a machine storage medium) or hardware components. A hardware component is a tangible unit capable of performing certain operations and may be configured or arranged in a certain physical manner. In various embodiments, one or more computer systems (e.g., a standalone computer system, a client computer system, or a server computer system) or one or more hardware components of a computer system (e.g., a processor 808 or a group of processors 804) may be configured by software (e.g., an application 716 or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor 808 or another programmable processor 808, Once configured by such software, hardware components become specific machines (or specific components of a machine 800) uniquely tailored to perform the configured functions and are no longer general-purpose processors 804. It will be appreciated that the decision to implement a hardware component mechanically, in dedicated and permanently configured circuitry, or in temporarily configured circuitry (e.g., configured by software) may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein, Considering embodiments in which hardware components are temporarily configured (e.g., programmed), each of the hardware components need not be configured or instantiated at any one instance in time. For example, where a hardware component comprises a general-purpose processor 808 configured by software to become a special-purpose processor, the general-purpose processor 808 may be configured as respectively different special-purpose processors comprising different hardware components) at different times. Software accordingly configures a particular processor 808 or processors 804, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In embodiments in which multiple hardware components are configured or instantiated at different times, communications between or among such hardware components may be achieved, for example, through the storage and retrieval of inthrmation in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

The various operations of example methods described herein may be performed, at least partially, by one or more processors 804 that are temporarily configured (e.g., by software) or permanently configured to perform the relevant operations. Whether temporarily or permanently configured, such processors 804 may constitute processor-implemented components that operate to perform one or more operations or functions described herein. As used herein, “processor-implemented component” refers to a hardware component implemented using one or more processors 804. Similarly, the methods described herein may be at least partially processor-implemented, with a particular processor 808 or processors 804 being an example of hardware. For example, at least some of the operations of a method may be performed by one or more processors 804 or processor-implemented components. Moreover, the one or more processors 804 may also operate to support performance of the relevant operations in a “cloud computing” environment or as a “software as a service” (SaaS). For example, at least some of the operations may be performed by a group of computers (as examples of machines 800 including processors 804), with these operations being accessible via a communications network 832 (e.g., the Internet) and via one or more appropriate interfaces (e.g., an API). The performance of certain of the operations may be distributed among the processors 804, not only residing within a single machine 800, but deployed across a umber of machines 800. In some embodiments, the processors 804 or processor-implemented components may be located in a single geographic location (e.g., within a home environment, an office environment, or a server farm). In other embodiments, the processors 804 or processor-implemented components may be distributed across a number of geographic locations.

“CLIENT DEVICE” in this context refers to any machine that interfaces to a communications network to obtain resources from one or more server systems or other client devices. A client device may be, but is not limited to, a mobile phone, desktop computer, laptop, PDA, smart phone, tablet, ultrabook, netbook, laptop, multi-processor system, microprocessor-based or programmable consumer electronics system, game console, set-top box, or any other communication device that a user may use to access a network.

“COMMUNICATIONS NETWORK” in this context refers to one or more portions of a network that may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or another type of cellular or wireless coupling. In this example, the coupling may implement any of a variety of types of data transfer technology, such as Single Carrier Radio Transmission Technology (1xRTT), Evolution-Data Optimized (EVDO) technology, General Packet Radio Service (CPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long range protocols, or other data transfer technology.

“MACHINE STORAGE MEDIUM” in this context refers to a component, a device, or other tangible media able to store instructions and data temporarily or permanently and may include, but is not limited to, random-access memory (RAM), read-only memory (ROM), buffer memory, flash memory, optical media, magnetic media, cache memory, other types of storage (e.g., erasable programmable read-only memory (EPROM)), and/or any suitable combination thereof. The term “machine storage medium” should be taken to include a single medium or multiple media (e.g., a centralized or distributed database, or associated caches and servers) able to store instructions. The term “machine storage medium” shall also be taken to include any medium, or combination of multiple media, that is capable of storing instructions (e.g., code) for execution by a machine, such that the instructions, when executed by one or more processors of the machine, cause the machine to perform any one or more of the methodologies described herein. Accordingly, a “machine storage medium” refers to a single storage apparatus or device, as well as “cloud-based” storage systems or storage networks that include multiple storage apparatus or devices. The machine storage medium is non-transitory and, as such, excludes signals per se. A computer storage medium is an example of a machine storage medium. The term “communications medium” in this context includes modulated data signals and other carrier/communication experience elements. The term “machine-readable medium” in this context includes both a machine storage medium (e.g., a computer storage medium) and a communications medium.

“PROCESSOR” in this context refers to any circuit (e.g., hardware processor) or virtual circuit (e.g., a physical circuit emulated by logic executing on an actual processor) that manipulates data values according to control signals (e.g., “commands,” “op codes,” “machine code,” etc.) and which produces corresponding output signals that are applied to operate a machine. A processor may, for example, be a central processing unit (CPU), a Reduced Instruction Set Computing (RISC) processor, a Complex Instruction Set Computing (CISC) processor, a graphics processing unit (GPU), a digital signal processor (DSP), an ASIC, a Radio-Frequency Integrated Circuit (RFIC), or any combination thereof. A processor may further be a multi-core processor having two or more independent processors (sometimes referred to as “cores”) that may execute instructions contemporaneously.

Throughout this specification, plural instances may implement resources, components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components.

As used herein, the term “or” may be construed in either an inclusive or exclusive sense. The terms “a” or “an” should be read as meaning “at least one,” “one or more,” or the like. The presence of broadening words and phrases such as “one or more,” “at least,” “but not limited to,” or other like phrases in some instances shall not be read to mean that the narrower case is intended or required in instances where such broadening phrases may be absent. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. The specification and drawings are, accordingly, to be regarded in an illustrative rather than a restrictive sense.

It will be understood that changes and modifications may be made to the disclosed embodiments without departing from the scope of the present disclosure. These and other changes or modifications are intended to be included within the scope of the present disclosure.

What is claimed is:

1. A method comprising:
accessing, by one or more hardware processors, historical data for a set of instances, wherein for a particular instance in the set of instances, wherein the historical data comprises, for a particular instance in the set of instances, a set of observed feature values for a set of features, an observed action value, and an observed outcome value for the observed action value;
generating, by the one or more hardware processors, an ensemble of decision trees based at least in part on the historical data such that for each given leaf node of decision trees in the ensemble, the given leaf node is associated with a contingency table of action-outcome value pairs, wherein the contingency table associated with the given leaf node is generated based at least in part on the set of observed feature values, the observed action value, and the observed outcome value for a given set of instances associated with the given leaf node, and wherein the given set of instances is included in the set of instances; and
storing, by the one or more hardware processors, the ensemble of decision trees as model data for subsequent access and use of the ensemble of decision trees.

2. The method of claim 1, wherein the generating the ensemble of decision trees comprises, for a particular decision tree in the ensemble:
generating a subsample of instances from the set of instances; and
generating the particular decision tree from a root non-leaf node to a plurality of leaf nodes based at least in part on the subsample of instances, wherein the generating the particular decision tree comprises, for each particular non-leaf node of the particular decision tree:
generating a set of candidate features from the set of features;
for each particular candidate feature in the set of candidate features, determining a set of possible splits for splitting a particular set of instances of the particular non-leaf node into a left set of instances for a left non-leaf node and a right set of instances for a right non-leaf node,
determining, from the set of possible splits, an optimal split for the particular set of instances;
associating the particular non-leaf node with a contingency table of action-outcome value pairs generated based at least in part on the particular set of instances of the particular non-leaf node;
determining whether the optimal split satisfies a leaf node criterion;
in response to determining that the optimal split does not satisfy the leaf node criterion, splitting the particular set of instances, according to the optimal split, into the left set of instances and the right set of instances; and
in response to determining that the optimal split satisfies the leaf node criterion, designating the particular non-leaf node to be a leaf node.

3. The method of claim 2, wherein the determining the set of possible splits for the particular candidate feature, into the left set of instances and into the right set of instances, is based at least in part on a split criterion at least defined by:
S(( [symbol] , [symbol] ); P)=C(P)−[C( [symbol] )+C( [symbol] )],
where [symbol] represents the left set of instances, where [symbol] represents the right set of instances, where P represents the particular set of instances such that P [symbol] U [symbol] , where for k number of actions,
C(U)=φ(r₀(U)+1)+φ(r₁(U)+1)−φ(N(U)+1)+Σᵢ₌₁^{k}φ(cᵢ(U)+1)−φ(a₀ᵢ(U)+1)−φ(a₁ᵢ(U)+1),
where φ represents a log function, where U represents the contingency table associated with the particular non-leaf node, where rᵢ(U) represents a sum of row i, cⱼ(U) represents a sum of column i, where aᵢⱼ(U) represents an entry of the contingency table U at row i, column j, and where N(U) represents a sum of row sums and column sums.

4. The method of claim 3, wherein the determining the optimal split is further based at least in part on an optimal split criterion at least defined by:
$$( {ℒ}^{*} , {ℛ}^{*} ) = {argmax}_{( ℒ , ℛ )} S ( ( ℒ , ℛ ) ; P ) ,$$
where [symbol] * represents the left set of instances according to the optimal split and where [symbol] represents the right set of instances according to the optimal split.

5. The method of claim 4, wherein the leaf node criterion specifies that optimal split satisfies a condition at least defined by:
S(( [symbol] , [symbol] ); P)<0.

6. The method of claim 2, wherein the determining the set of possible splits for each particular candidate feature in the set of candidate features comprises subgrouping values of the particular candidate features.

7. The method of claim 2, wherein the determining the set of possible splits for each particular candidate feature in the set of candidate features comprises ordering values of the particular candidate features.

8. A method comprising:
accessing, by one or more hardware processors, model data comprising an ensemble of decision trees trained on historical data for a set of instances, wherein for a particular instance in the set of instances, the historical data comprises a set of observed feature values for a set of features, an observed action value, and an observed outcome value for the observed action value, and wherein each leaf node of decision trees in the ensemble is associated with a contingency table of action-outcome value pairs generated based at least in part on the historical data;
accessing, by the one or more hardware processors, input data comprising a set of new feature values for the set of features; and
generating, by the one or more hardware processors, prediction data by processing the input data using the ensemble, the prediction data comprising a predicted action value for the set of new feature values.

9. The method of claim 8, wherein the generating the prediction data comprises:
determining a set of particular contingency tables of action-outcome value pairs from leaf nodes of the decisions trees in the ensemble by processing the set of new feature values using each particular decision tree, in the ensemble, to determine a particular contingency table of a leaf node of the particular decision tree; and
determining the predicted action value for the set of new feature values by combining the set of particular contingency tables.

10. The method of claim 9, wherein the combining the set of particular contingency tables comprises:
determining a set of best action values for the set of particular contingency tables by determining, for each given contingency table in the set of particular contingency tables, a best action value voted for by a given decision tree in the ensemble based at least in part on the given contingency table associated with the given decision tree;
determining a set of counts for one or more different action values by determining a count for each different action value in the set of best action values; and
selecting the predicted action value, from the one or more different action values, based at least in part on the set of counts.

11. The method of claim 9, wherein the combining the set of particular contingency tables comprises:
determining a set of counts for one or more different action-outcome value pairs by determining a count for each different action-outcome value pair in the set of particular contingency tables; and
selecting the predicted action value, from the one or more different action-outcome value pairs, based at least in part on the set of counts.

12. The method of claim 9, wherein the contingency table comprises a 2×k contingency table, where k represents number of different action values.

13. A non-transitory computer-readable medium comprising instructions that, when executed by one or more hardware processors of a machine, cause the machine to perform operations comprising:
accessing historical data for a set of instances, wherein the historical data comprises, for a particular instance in the set of instances, a set of observed feature values for a set of features, an observed action value, and an observed outcome value for the observed action value:
generating, by the one or more hardware processors, an ensemble of decision trees based at least in part on the historical data such that for each given leaf node of decision trees in the ensemble, the given leaf node is associated with a contingency table of action-outcome value pairs, wherein the contingency table associated with the given leaf node is generated based at least in part on the set of observed feature values, the observed action value, and the observed outcome value for a given set of instances associated with the given leaf node, and wherein the given set of instances is included in the set of instances; and
storing the ensemble of decision trees as model data for subsequent access and use of the ensemble of decision trees.

14. The non-transitory computer-readable medium of claim 13, wherein the generating the ensemble of decision trees comprises, for a particular decision tree in the ensemble:
generating a subsample of instances from the set of instances; and
generating the particular decision tree from a root non-leaf node to a plurality of leaf nodes based at least in part on the subsample of instances, wherein the generating the particular decision tree comprises, for each particular non-leaf node of the particular decision tree:
generating a set of candidate features from the set of features;
for each particular candidate feature in the set of candidate features, determining a set of possible splits for splitting a particular set of instances of the particular non-leaf node into a left set of instances for a left non-leaf node and a right set of instances for a right non-leaf node,
determining, from the set of possible splits, an optimal split for the particular set of instances;
associating the particular non-leaf node with a contingency table of action-outcome value pairs based at least in part on the particular set of instances of the particular non-leaf node;
determining whether the optimal split satisfies a leaf node criterion;
in response to determining that the optimal split does not satisfy the leaf node criterion, splitting the particular set of instances, according to the optimal split, into the left set of instances and the right set of instances; and
in response to determining that the optimal split satisfies the leaf node criterion, designating the particular non-leaf node to be a leaf node.

15. The non-transitory computer-readable medium of claim 14, wherein the determining the set of possible splits for the particular candidate feature, into the left set of instances and into the right set of instances, is based at least in part on a split criterion at least defined by:
S(( [symbol] , [symbol] ); P)=C(P)=C(P)−[C( [symbol] )+C( [symbol] )].
where [symbol] represents the left set of instances, where [symbol] represents the right set of instances, where P represents the particular set of instances such that P= [symbol] U [symbol] , where for k number of actions
C( [symbol] )=φ(r₀(U)+1)+φ(r₁(U)+1)−φ(N(U)+1)+Σᵢ₌₁^{k}φ(cᵢ(U)+1)−φ(a₀ᵢ(U)+1)−φ(a₁ᵢ(U)+1),
where φ represents a log function, where U represents the contingency table associated with the particular non-leaf node, where rᵢ (U) represents a sum of row i, cⱼ(U) represents a sum of column i, where aᵢⱼ(U) represents an entry of the contingency table U at row i, column j, and where N(U) represents a sum of row sums and column sums.

16. The non-transitory computer-readable medium of claim 15, wherein the determining the optimal split is further based at least in part on an optimal split criterion at least defined by:
$$( {ℒ}^{*} , {ℛ}^{*} ) = {argmax}_{( ℒ , ℛ )} S ( ( ℒ , ℛ ) ; P ) .$$

17. The non-transitory computer-readable medium of claim 16, wherein the leaf node criterion specifies that the optimal split satisfies a condition at least defined by:
S(( [symbol] , [symbol] ); P)<0.

18. The non-transitory computer-readable medium of claim 14, wherein the determining the set of possible splits for each particular candidate feature in the set of candidate features comprises subgrouping values of the particular candidate features.

19. The non-transitory computer-readable medium of claim 14, wherein the determining the set of possible splits for each particular candidate feature in the set of candidate features comprises ordering values of the particular candidate features.

20. A system comprising:
one or more hardware processors; and
a memory storing instructions configured to instruct the one or more hardware processors to perform operations of:
accessing model data comprising an ensemble of decision trees trained on historical data for a set of instances, wherein for a particular instance in the set of instances, the historical data comprises a set of observed feature values for a set of features, an observed action value, and an observed outcome value for the observed action value, and wherein each leaf node of decision trees in the ensemble is associated with a contingency table of action-outcome value pairs generated based at least in part on the historical data;
accessing input data based at least in part on device data received from an Industrial Internet-of-Things (IIoT) device, the input data comprising a set of new feature values for the set of features; and
generating prediction data by processing the input data using the ensemble, the prediction data comprising a predicted action value for the set of new feature values.
